(19) United States
(12) Patent Application Publication
(10) Pub. No.: US 2026/0008168 A1
(43) Pub. Date: Jan. 8, 2026

(54) FLUX BRAKING IN A POWER TOOL

(71) Applicant: MILWAUKEE ELECTRIC TOOL CORPORATION, Brookfield, WI (US)

(72) Inventors: Andrew McCartney, Libertyville, IL (US); Douglas R. Fieldbinder, Greendale, WI (US)

(21) Appl. No.: 19/123,735

(22) PCT Filed: Oct. 30, 2023
(86) PCT No.: PCT/US2023/078203

§ 371 Date: Apr. 23, 2025

Related U.S. Application Data
(60) Provisional application No. 63/381,858, filed on Nov. 1, 2022.
(60) Provisional application No. 63/480,121, filed on Jan. 17, 2023.

(51) Int. Cl. B25F 5/02; H02P 21/36

(52) U.S. Cl. CPC B25F 5/02; H02P 21/36

(57) ABSTRACT

A power tool including a housing, a handle, and a brushless motor within the housing. The brushless motor includes a rotor and a stator. The power tool also includes a sensor to sense a parameter of the brushless motor, a power switching circuit configured to provide a supply of power from a power source to the brushless motor, and an electronic controller to apply a field-oriented control (“FOC”) technique to control the brushless motor. The electronic controller is configured to receive, via the sensor, a first signal indicative of a braking operation of the brushless motor, generate a second signal to control a first component of a current of the brushless motor to brake the brushless motor, and generate a third signal to control a second component of a current of the brushless motor to brake the brushless motor.

### RELATED APPLICATIONS

This application claims the benefit of U.S. Provisional Patent Application No. 63/480,121, filed Jan. 17, 2023, and U.S. Provisional Patent Application No. 63/381,858, filed Nov. 1, 2022, the entire content of each of which is hereby incorporated by reference.

### FIELD

Embodiments described herein relate to power tools.

### SUMMARY

Conventional brushless direct current (“DC”) motors include a stator and a rotor configured to rotate with respect to the stator by a magnetic field generated in one or more phases of the stator. Typically, the stator and rotor are separated by an air-gap. In order to properly generate the magnetic field in the correct phase(s), conventional brushless DC motors further include a sensor, such as a Hall effect sensor, configured to sense an angular position of the rotor with respect to the stator. Some brushless DC motors may not include this sensor. These motors are known as sensorless brushless DC motors (or simply “sensorless motors”). In order to properly generate the magnetic field in the correct phase(s), motors may employ one or more control algorithms to estimate the position of the rotor, and control the phases of the stator. One such control algorithm is known as field-oriented control (“FOC”).

In FOC, both the stator and the rotor produce flux. In particular, the stator flux current, i_{d}, and the stator torque current, i_{q}, are two component currents making up the stator current vector, Iₛ, within a rotating reference frame. Therefore, stator flux can be determined as a function of stator current. The goal of FOC is to align the stator flux to be orthogonal to the rotor flux. To accomplish this, motors may contain means to measure a current of the stator, such as shunt resistors, to determine a position of the rotor. Once the position of the rotor is known, motors may control the phases of the stator to produce the proper magnetic field such that the stator flux remains orthogonal to the rotor flux. Controlling a motor via FOC provides various benefits, such as independent control of motor speed and motor torque.

In motors implementing FOC, the motor can be actively braked by controlling the stator flux current, i_{d}, separately from the stator torque current, i_{q}. This is referred to herein as flux braking. Flux braking increases the magnetic flux of the motor by actively controlling the stator flux current, i_{d}, and the stator torque current, i_{q}. For example, energy from the motor braking is absorbed in the motor itself in the form of heat from magnetizing current. Some motor braking applications allow the energy to be absorbed by a battery pack in what is commonly referred to as regenerative braking.

Resistive braking methods have been used to avoid regenerative currents. Resistive braking methods utilize the motor control power switches to absorb energy or have separate resistive elements within the brushless motor to absorb energy. For brushless motors that operate with a range of battery packs with widely varying capacities, allowing regenerative current into the battery may exceed the safe charge rate for lower capacity battery packs. Flux braking uses the brushless motor, which is designed to operate at high currents, to absorb the braking energy and avoid regenerative currents and without using separate energy absorbing elements. In some examples, this requires the brushless motor to brake slowly to maintain the regenerative current at a low level. Implementation of flux braking allows for tunable braking control through feedback mechanisms to control the stator flux current, i_{d}. Flux braking control can be tuned on an application-specific basis to achieve short braking times without regenerative currents, or flux braking is tuned with a longer duration to achieve a controlled deceleration for loads with larger inertias. Flux braking also does not require any switches (e.g., FETs, drive switches, etc.) or other devices to protect a battery pack during braking.

Embodiments described herein provide a power tool implementing flux braking. In particular, embodiments described herein provide a power tool including a housing, a handle, a brushless motor within the housing, wherein the brushless motor includes a rotor and a stator, wherein the rotor is coupled to a motor shaft arranged to rotate about a longitudinal axis, the longitudinal axis extending through the motor shaft, and wherein the motor shaft is arranged to produce a rotational output to a drive mechanism, a sensor configured to sense a parameter of the brushless motor, and a power switching circuit configured to provide a supply of power from a power source to the brushless motor. The power tool further includes an electronic controller configured to apply a field-oriented control (“FOC”) technique to control the brushless motor. The electronic controller is configured to receive, via the sensor, a first signal indicative of a braking operation of the brushless motor, generate a second signal to control a first component of a current of the brushless motor to brake the brushless motor, and generate a third signal to control a second component of a current of the brushless motor to brake the brushless motor.

In some aspects, the electronic controller is further configured to determine, in response to the third signal, whether the third signal is sufficient to brake the brushless motor and generate, in response to determining the third signal is insufficient, a fourth signal to control the second component of the current, the fourth signal different than the third signal.

In some aspects, the first component of the current indicates a torque producing current (i_{q}).

In some aspects, the second component of the current indicates a flux producing current (i_{d}).

In some aspects, to generate the third signal to control the second component of the current includes the electronic controller being configured to the control second component of the current to have a positive magnitude.

In some aspects, to generate the second signal to control the first component of the current includes the electronic controller being configured to control the first component of current to be zero.

In some aspects, the electronic controller is further configured to determine a battery voltage while braking the brushless motor, determine a battery current while braking the brushless motor, determine a rotational speed of the brushless motor while braking the brushless motor, and supply the fourth signal to the brushless motor based on at least one selected from a group consisting of the battery voltage, the battery current, and the rotational speed.

Embodiments described herein provide a method for controlling a power tool. The method includes receiving, via a sensor, a first signal indicative of a braking operation of a brushless motor, generating a second signal to control a first component of a current of the brushless motor to brake the brushless motor, and generating a third signal to control a second component of the current of the brushless motor to brake the brushless motor.

In some aspects, the methods described herein further include determining, in response to the third signal, whether the third signal is sufficient to brake the brushless motor and supplying, in response to determining the third signal is insufficient, a fourth signal to the brushless motor to control the second component of the current, the fourth signal different than the third signal.

In some aspects, the first component of the current indicates a torque producing current (i_{q}).

In some aspects, the second component of the current indicates a flux producing current (i_{d}).

In some aspects, supplying the third signal controls the second component of the current to have a positive magnitude.

In some aspects, supplying the second signal to the brushless motor to control the first component of the current includes controlling the first component of current to be zero.

In some aspects, the methods described herein further include determining a battery voltage while braking the brushless motor, determining a battery current while braking the brushless motor, determining a rotational speed of the brushless motor while braking the brushless motor, and supplying the fourth signal to the brushless motor based on at least one selected from a group consisting of the battery voltage, the battery current, and the rotational speed.

Embodiments described herein provide a power tool implementing flux braking and a subsequent driving operation. In particular, embodiments described herein provide a power tool including a housing, a handle, a brushless motor within the housing, wherein the brushless motor includes a rotor and a stator, wherein the rotor is coupled to a motor shaft arranged to rotate about a longitudinal axis, the longitudinal axis extending through the motor shaft, and wherein the motor shaft is arranged to produce a rotational output to a drive mechanism, a sensor configured to sense a parameter of the brushless motor, and a power switching circuit configured to provide a supply of power from a power source to the brushless motor. The power tool further includes an electronic controller configured to apply a field-oriented control (“FOC”) technique to control the brushless motor. The electronic controller is configured to receive, after a flux braking operation of the brushless motor and via the sensor, a first signal indicative of a driving operation of the brushless motor, generate a second signal to control a first component of a current of the brushless motor to drive the brushless motor, and generate a third signal to control a second component of the current of the brushless motor to drive the brushless motor.

In some aspects, the first component of the current indicates a torque producing current (i_{q}).

In some aspects, the second component of the current indicates a flux producing current (i_{d}).

In some aspects, to generate the third signal includes the electronic controller being configured to reduce the second component of the current to be zero.

In some aspects, to reduce the second component to zero maximizes torque supplied by the brushless motor.

In some aspects, the electronic controller is further configured to receive a user input and brake, in response to the user input, the brushless motor.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool implementing flux braking, according to some embodiments.

FIG. 2 illustrates a cross-sectional view of a power tool implementing flux braking, according to some embodiments.

FIG. 3 illustrates a control system for a power tool implementing flux braking, according to some embodiments.

FIG. 4 is a block diagram for the control system of a field-oriented control algorithm for use in a power tool, according to some embodiments.

FIG. 5 is a graph illustrating a relationship between stator flux current and stator torque current, according to some embodiments.

FIG. 6 is a graph illustrating a negative stator flux current for use in field-oriented control determined by a max-torque-per-amps (“MTPA”) algorithm, according to some embodiments.

FIG. 7 is a graph illustrating a relationship between stator flux current and stator torque current, according to some embodiments.

FIG. 8 is a graph illustrating the results of a field-oriented control operation, according to some embodiments.

FIG. 9 is a graph illustrating a relationship between stator flux current and stator torque current while driving a motor, according to some embodiments.

FIG. 10 is a graph illustrating a relationship between stator flux current and stator torque current while flux braking a motor, according to some embodiments.

FIGS. 11A-11B are a flow chart of a method for implementing field-oriented control of a motor, according to some embodiments.

FIG. 12 is a flow chart of a method for implementing flux braking, according to some embodiments.

### DETAILED DESCRIPTION

Embodiments described herein relate to power tools, such as handheld power tools, that implement a brushless direct-current motor (“brushless motor”), field-oriented control (“FOC”), and flux braking.

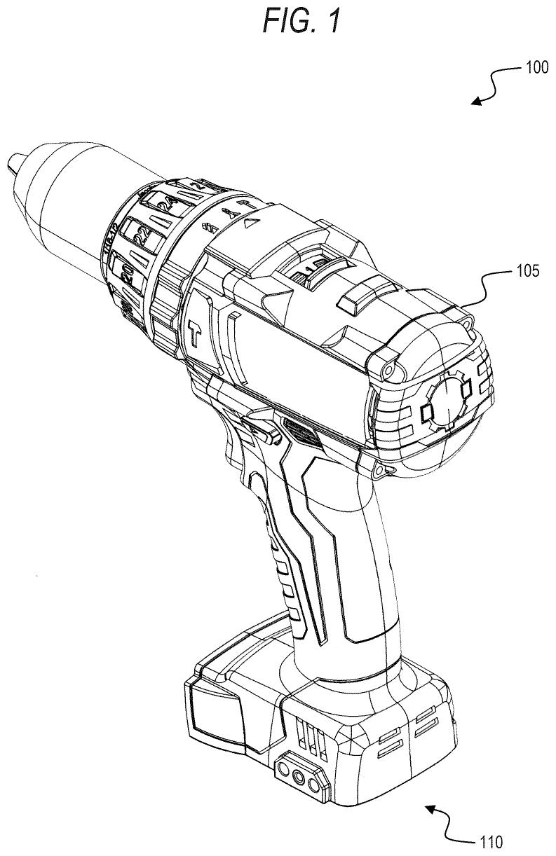

FIG. 1 illustrates a power tool 100 that implements flux braking. In the embodiment illustrated in FIG. 1, the power tool 100 is a drill/driver. In other embodiments, the power tool 100 is a different type of power tool (e.g., an impact wrench, a ratchet, a saw, a hammer drill, an impact driver, a rotary hammer, a grinder, a blower, a trimmer, etc.) or a different type of device (e.g., a light, etc.). The power tool 100 includes a housing 105 and a battery pack interface 110 for connecting the power tool 100 to, for example, a battery pack. In some embodiments, the battery pack interface 110 may be configured to connect the power tool 100 to another device.

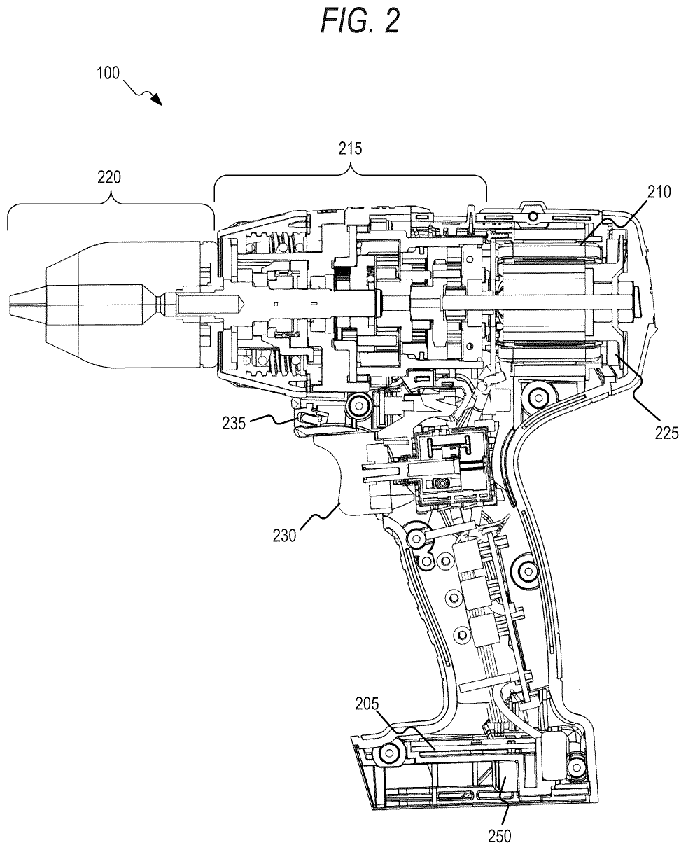

FIG. 2 illustrates a cross section of the power tool 100 of FIG. 1. The power tool 100 includes at least one printed circuit board (“PCB”) 205 for various components of the power tool 100. In some embodiments, the PCB 205 is a control PCB. In addition to or instead of the control PCB, the power tool 100 may include a power PCB, a forward/reverse PCB, and/or a light-emitting diode (“LED”) PCB. The power tool 100 may further include a motor 210. In some embodiments, the motor 210 may be a sensorless motor. In other embodiments, the motor 210 may be a sensored motor. Also illustrated in FIG. 2 is a drive mechanism 215 for transmitting the rotational output of the motor 210 to an output unit 220, and a cooling fan 225 rotated by the motor 210 and used to provide a cooling air flow over components of the power tool 100. The power tool 100 may further include a trigger 230 configured to be actuated by a user. In some embodiments, an amount of actuation of the trigger 230 may be used to determine an amount of power supplied to the motor 210. The power tool 100 may further include a work light 235 configured to illuminate a working area of the power tool 100. In some embodiments, the work light 235 may be mounted below the drive mechanism 215. In some embodiments, the work light 235 may be configured to be activated in response to an actuation of the trigger 230.

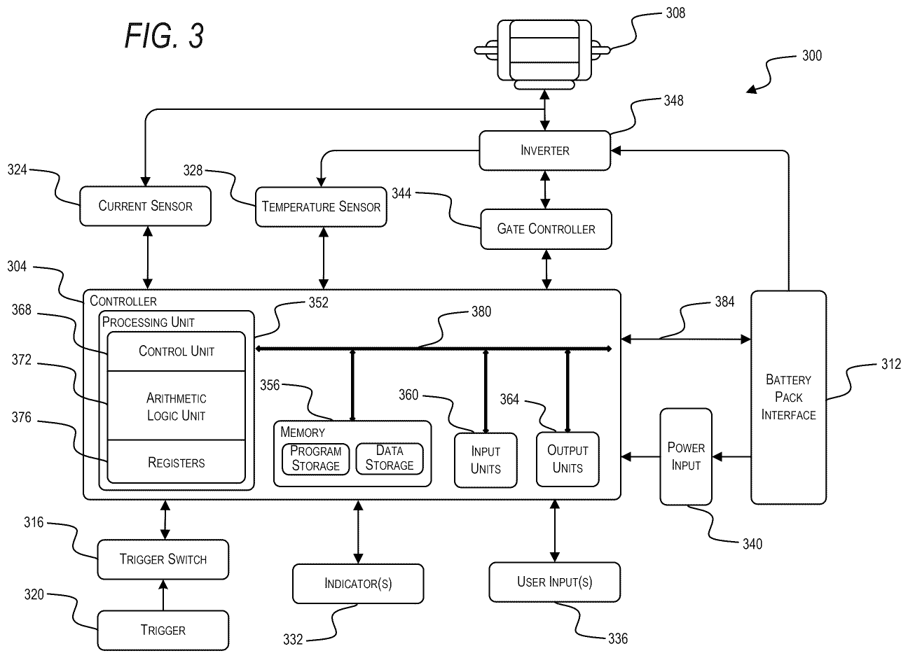

FIG. 3 illustrates a control system 300 for a power tool implementing flux braking (for example, the power tool 100 of FIG. 1). The control system 300 includes a controller 304. The controller 304 is electrically and/or communicatively connected to a variety of modules or components of the power tool 100. For example, the illustrated controller 304 is electrically connected to a motor 308 (for example, the motor 210 of FIG. 2), a battery pack interface 312 (for example, the battery pack interface 110 of FIG. 1), a trigger switch 316 (connected to a trigger 320, for example, the trigger 230 of FIG. 2), one or more sensors including at least a current sensor 324 and a temperature sensor 328, one or more indicators 332, one or more user input modules 336, a power input module 340, and a gate controller 344 (connected to an inverter 348). The motor 308 includes a rotor, a stator, and a shaft that rotates about a longitudinal axis.

The controller 304 includes combinations of hardware and software that are operable to, among other things, control the operation of the power tool 100, monitor the operation of the power tool, activate the one or more indicators 332 (e.g., an LED), etc. The gate controller 344 is configured to control the inverter 348 to convert a DC power supply to a three-phase signal for powering the phases of the motor 308. The current sensor 324 is configured to, for example, sense a current between the inverter 348 and the motor 308. The temperature sensor 328 is configured to, for example, sense a temperature of the inverter 348.

The controller 304 includes a plurality of electrical and electronic components that provide power, operational control, and protection to the components and modules within the controller 304 and/or the power tool 100. For example, the controller 304 includes, among other things, a processing unit 352 (e.g., a microprocessor, a microcontroller, or another suitable programmable device), a memory 356, input units 360, and output units 364. The processing unit 352 includes, among other things, a control unit 368, an arithmetic logic unit (“ALU”) 372, and a plurality of registers 376 (shown as a group of registers in FIG. 3), and is implemented using a known computer architecture (e.g., a modified Harvard architecture, a von Neumann architecture, etc.). The processing unit 352, the memory 356, the input units 360, and the output units 364, as well as the various modules or circuits connected to the controller 304 are connected by one or more control and/or data buses (e.g., common bus 380). The control and/or data buses are shown generally in FIG. 3 for illustrative purposes. The use of one or more control and/or data buses for the interconnection between and communication among the various modules, circuits, and components would be known to a person skilled in the art in view of the invention described herein.

The memory 356 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 352 is connected to the memory 356 and executes software instructions that are capable of being stored in a RAM of the memory 356 (e.g., during execution), a ROM of the memory 356 (e.g., on a generally permanent basis), or another non-transitory computer readable medium such as another memory or a disc. Software included in the implementation of the power tool can be stored in the memory 356 of the controller 304. The software includes, for example, firmware, one or more applications, program data, filters, rules, one or more program modules, and other executable instructions. The controller 304 is configured to retrieve from the memory 356 and execute, among other things, instructions related to the control processes and methods described herein. In other constructions, the controller 304 includes additional, fewer, or different components.

The battery pack interface 312 includes a combination of mechanical components (e.g., rails, grooves, latches, etc.) and electrical components (e.g., one or more terminals) configured to and operable for interfacing (e.g., mechanically, electrically, and communicatively connecting) the power tool 100 with a battery pack. For example, power provided by the battery pack to the power tool is provided through the battery pack interface 312 to the power input module 340. The power input module 340 includes combinations of active and passive components to regulate or control the power received from the battery pack prior to power being provided to the controller 304. The battery pack interface 312 also supplies power to the inverter 348 to be switched by the switching FETs to selectively provide power to the motor 308. The battery pack interface 312 also includes, for example, a communication line 384 to provide a communication line or link between the controller 304 and the battery pack.

The indicators 332 include, for example, one or more light-emitting diodes (“LEDs”). The indicators 332 can be configured to display conditions of, or information associated with, the power tool 100. For example, the indicators 332 are configured to indicate measured electrical characteristics of the power tool, the status of the device, etc. The one or more user input modules 336 may be operably coupled to the controller 304 to, for example, select a forward mode of operation or a reverse mode of operation, a torque and/or speed setting for the power tool (e.g., using torque and/or speed switches), etc. In some embodiments, the one or more user input modules 336 may include a combination of digital and analog input or output devices required to achieve a desired level of operation for the power tool, such as one or more knobs, one or more dials, one or more switches, one or more buttons, etc. In some embodiments, the one or more user input modules 336 may receive signals wirelessly from a device external to the power tool (e.g., a user's mobile phone).

The controller 304 may be configured to determine whether a fault condition of the power tool is present and generate one or more control signals related to the fault condition. For example, the controller 304 may calculate or include, within memory 356, predetermined operational threshold values and limits for operation of the power tool. For example, when a potential thermal failure (e.g., of a FET, the motor 308, etc.) is detected or predicted by the controller 304, power to the motor 308 can be limited or interrupted until the potential for thermal failure is reduced. If the controller 304 detects one or more such fault conditions of the power tool or determines that a fault condition of the power tool no longer exists, the controller 304 may be configured to provide information and/or control signals to another component of the power tool (e.g. the battery pack interface 312, the indicators 332, etc.). The signals can be configured to, for example, trip or open a fuse of the power tool, reset a switch, brake (e.g., flux brake) the motor 308, etc.

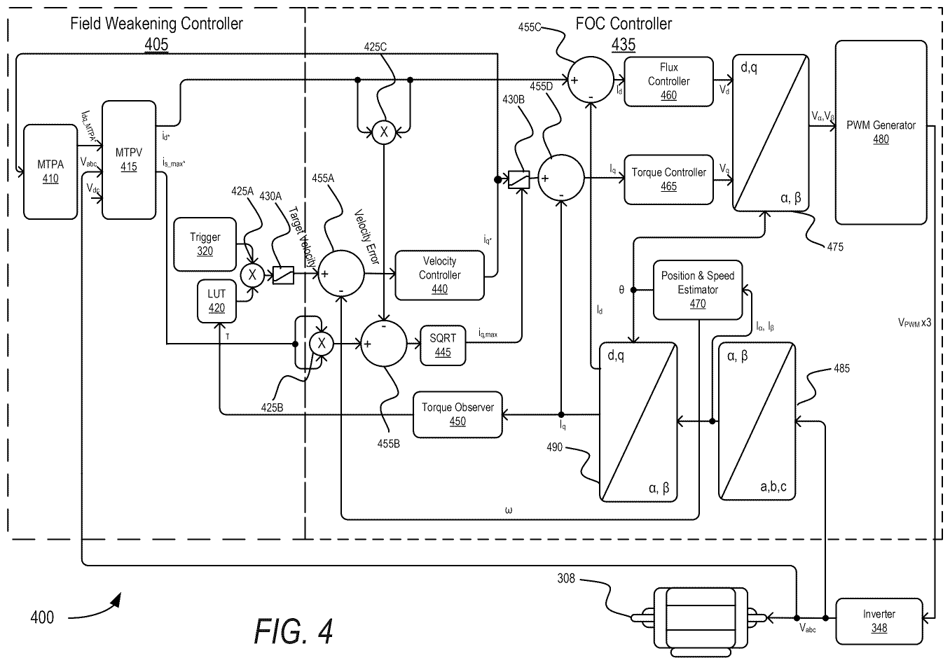

FIG. 4 is a block diagram for a control system 400 of a field-oriented control algorithm for use in the power tool 100. The control system 400 can be implemented by the controller 304 and can include one or more additional controllers (e.g., dedicated controllers). For example, as illustrated by FIG. 4, the control system 400 includes a field weakening controller 405 and a field-oriented control (“FOC”) controller 435. The field weakening controller 405 and the FOC controller 435 may include one or more mathematical operator blocks, such as multiplication blocks 425A-C which multiply two or more input values, linear scaling blocks 430A-B which linearly scale an input value based on a scaling factor, square root blocks 445 which determine the square root of an input value, and/or addition/subtraction blocks 455A-D which add or subtract two or more input values. In some embodiments the mathematical operator blocks may perform different mathematical operations. For example, the linear scaling blocks 430A-B may scale a value up or down based on a non-linear function. The field weakening controller 405 and the FOC controller 435 may each include one or more components that are configured to send and receive signals between the field weakening controller 405 and the FOC controller 435.

The field weakening controller 405 includes a control block for controlling a max-torque-per-amps (“MTPA”) algorithm (“MTPA block 410”) and a control block for controlling a max-torque-per-volts (“MTPV”) algorithm (“MTPV block 415”). The MTPA block 410 receives one or more inputs, such as an input i_{q}* from the FOC controller 435 relating to a torque current. The MTPA block 410 may perform one or more mathematical operations to generate and output a signal I_{dq_MTPA}* relating to a flux current and a torque current. The MTPV block 415 receives one or more signals, such as an input I_{dq_MTPA}* from the MTPA block 410 relating to a flux current and a torque current, an input V_{abc} relating to voltages applied to the phases of the motor 308, and/or an input V_{dc} relating to a voltage of a battery pack connected to the power tool 100. The MTPV block 415 may further generate one or more output signals, such as a signal i_{d}* relating to a flux current determined by the MTPV block 415 and/or a signal i_{s_max}* relating to a maximum current of a stator of the motor 308 determined by the MTPV block 415.

The field weakening controller 405 may further include a look-up table (“LUT”) 420 which contains one or more output values based on one or more input values. For example, the LUT 420 may receive a signal τ relating to a present torque of the motor 308. The LUT 420 may determine and output a signal based on the received torque signal τ. In some embodiments, the LUT 420 is a speed map. The speed map receives an estimated load torque as an input, and outputs a speed reference value based on the estimated load torque. The speed map may be modifiable by a user to create tool-specific speed-torque characteristics. The field weakening controller 405 may further include a first multiplication block 425A which receives a first signal from the LUT 420 and a second signal from the trigger 320 of the power tool 100, and multiplies the first and second signals to generate an output signal. The field weakening controller 405 may further include a first linear scaling block 430A which receives a signal from the first multiplication block 425A and scales the signal based on a linear function, and outputs a signal corresponding to the result of the scaling. In some embodiments, the function is non-linear. The signal output by the first linear scaling block 430A may be a target velocity for the motor 308.

The FOC controller 435 includes a first addition/subtraction block 455A configured to add a first signal received from the first linear scaling block 430A corresponding to a target velocity for the motor 308 and to subtract a second signal o corresponding to a present velocity of the motor 308. The first addition/subtraction block 455A may be further configured to output a signal corresponding to the result of the first addition/subtraction block 455A. The signal output by the first addition/subtraction block 455A may be a velocity error of the motor 308. The FOC controller 435 may further include a velocity controller 440 configured to receive a signal from the first addition/subtraction block 455A corresponding to a velocity error of the motor 308. The velocity controller 440 may generate an output signal i_{q}* based on the velocity error and output the output signal i_{q}* to the MTPA block 410.

The FOC controller 435 may further include a second multiplication block 425B configured to receive two signals i_{s_max}* (i.e., the same signal twice) from the MTPV block 415 of the field weakening controller 405. The second multiplication block 425B may multiply the two signals i_{s_max}* together to generate a squared value of i_{s_max}* and generate an output signal corresponding to the squared value of i_{s_max}*. The FOC controller 435 may further include a third multiplication block 425C configured to receive two signals i_{d}* (i.e., the same signal twice) from the MTPV block 415 of the field weakening controller 405. The third multiplication block 425C may multiply the two signals i_{d}* together to generate a squared value of i_{d}*, and generate an output signal corresponding to the squared value of i_{d}*. The FOC controller 435 may further include a second addition/subtraction block 455B configured to receive and add a first signal from the second multiplication block 425B corresponding to the squared value of i_{s_max}*. The second addition/subtraction block 455B may be further configured to receive and subtract a second signal from the third multiplication block 425C corresponding to the squared value of i_{d}*. The second addition/subtraction block 455B may be further configured to generate an output signal corresponding to the result of the second addition/subtraction block 455B. The FOC controller 435 may further include a square root block 445 configured to receive a signal from the second addition/subtraction block 455B corresponding to a result of the second addition/subtraction block 455B. The square root block 445 may be further configured to generate and output a signal i_{q,max} corresponding to a square root value of the signal received from the second addition/subtraction block 455B. That is to say, the combination of the second multiplication block 425B, the third multiplication block 425C, the second addition/subtraction block 455B, and the square root block 445 may be configured to perform a Pythagorean operation on the outputs of the MTPV block 415 to break the current Iₛ of the stator of the motor 308 into its component vectors, the flux current i_{d} and the torque current i_{q}.

The FOC controller 435 may further include a third addition/subtraction block 455C configured to receive and add a first signal i_{d}* from the MTPV block 415 corresponding to the flux current determined by the MTPV block 415. The third addition/subtraction block 455C may be further configured to receive and subtract a second signal I_{d} corresponding to a total flux current of the motor 308. The third addition/subtraction block 455C may be configured to output a signal I_{d} corresponding to the result of the third addition/subtraction block 455C. The FOC controller 435 may further include a flux controller 460 configured to receive an input signal I_{d} from the third addition/subtraction block 455C and generate and output a flux voltage signal V_{d} based on the input signal I_{d}.

The FOC controller 435 further includes a second linear scaling block 430B configured to receive a first signal i_{q}* from the velocity controller 440 and a second signal i_{q,max} from the square root block 445. The second linear scaling block 430B may be further configured to linearly scale the first signal i_{q}* based on the second signal i_{q,max} and output a signal corresponding to the result of the second linear scaling block 430B. The FOC controller 435 further includes a fourth addition/subtraction block 455D configured to receive and add a first signal corresponding to the result of the second linear scaling block 430B. The fourth addition/subtraction block 455D may be further configured to receive and subtract a second signal I_{q} corresponding to a total torque current of the motor 308. The fourth addition/subtraction block 455D may be configured to output a signal I_{q} corresponding to the result of the fourth addition/subtraction block 455D. The FOC controller 435 may further include a torque controller 465 configured to receive an input signal I_{q} from the fourth addition/subtraction block 455D and generate and output a torque voltage signal V_{q} based on the input signal I_{q}.

The FOC controller 435 may further include an inverse Park transform block 475 configured to receive a first signal V_{d} from the flux controller corresponding to a flux voltage, a second signal V_{q} from the torque controller corresponding to a torque voltage, and a third signal θ corresponding to a present angular position of a rotor of the motor 308. The inverse Park transform block 475 may be configured to convert the first signal V_{d} and second signal V_{q} to orthogonal stationary reference frame quantities V_{α} and V_{β} based on the third signal θ. The inverse Park transform block 475 may be further configured to output a signal corresponding to the orthogonal stationary reference frame quantities V_{α} and V_{β}. The FOC controller 435 may further include a PWM generator 480 including an inverse Clarke transform block, a PWM modulator, or both. The PWM generator 480 may be configured to receive the signal corresponding to the orthogonal stationary reference frame quantities V_{α} and V_{β} from the inverse Park transform block 475 and generate a plurality of pulse-width modulated (“PWM”) control signals V_{PWMX}3 configured to control the inverter 348. The inverter 348 may be configured to receive the plurality of PWM control signals V_{PWMX}3 and convert a DC power supply to a three-phase signal V_{abc} for controlling the motor 308. The three-phase signal V_{abc} may also be received by the MTPV block 415.

The FOC controller 435 further includes a three-phase-to-two-phase reference frame converter 485 configured to receive the three-phase signal V_{abc} from the inverter and generate and output a two-phase current signal I_{α}, I_{β} based on the three-phase signal V_{abc}. The FOC controller 435 furthers include a position and speed estimator 470 configured to receive the two-phase current signal I_{α}, I_{β} from the three-phase-to-two-phase reference frame converter 485 and estimate a position and speed of the motor 308 based on the two-phase current signal I_{α}, I_{β}. The position and speed estimator 470 may be further configured to output a first signal η relating to the current angular position of the rotor of the motor 308 and a second signal ω relating to the present rotational speed of the rotor of the motor 308. The first signal θ is received by the inverse Park transform block 475. The second signal ω is also received by the first addition/subtraction block 455A. The FOC controller 435 further includes a Park transform block 490 configured to receive the two-phase current signal I_{α}, I_{β} from the three-phase-to-two-phase reference frame converter 485 and the first signal θ relating to the present angular position of the rotor of the motor 308 from the position and speed estimator 470. The Park transform block 490 is further configured to generate a first signal I_{q} corresponding to a total torque current of the motor 308 and a second signal I_{d} corresponding to a total flux current of the motor 308 based on the two-phase current signal I_{α}, I_{β} and the first signal θ. The first signal I_{q} may be received by the torque observer 450 and the fourth addition/subtraction block 455D. The second signal I_{d} may be received by the third addition/subtraction block 455C.

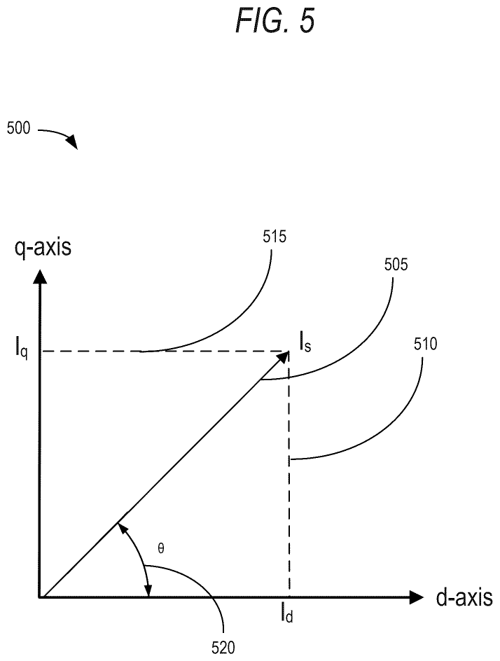

FIG. 5 is a graph 500 illustrating a relationship between stator flux current and stator torque current on a q-d coordinate plane. The graph 500 illustrates that the stator flux current i_{d} 510 and the stator torque current i_{q} 515 are both component vectors of the stator current Iₛ 505. In particular, as illustrated by the graph 500, i_{d} 510 can be calculated as a function of Iₛ 505 and the angle between Iₛ 505 and the d-axis, θ 520, by equation (1).

$${i}_{d} = {I}_{s} cos θ \qquad ( 1 )$$

Similarly, as illustrated by the graph 500, i_{q} 515 can be calculated as a function of Iₛ 505 and θ 520 by equation (2).

$${i}_{q} = {I}_{s} sin θ \qquad ( 2 )$$

A brushless motor (for example, the motor 308 of FIG. 3), includes a rotor with a permanent magnet. This permanent magnet generates magnetic saliency, which in turn produces a reluctance torque from the difference between an inductance on the d-axis and an inductance on the q-axis. The reluctance torque, Tₑ, can be determined by equation (3), where P is the number of pole pairs of the motor, φ_{f} is the stator flux, L_{d} is a direct inductance on the d-axis, and L_{q} is a quadrature inductance on the q-axis.

$${T}_{e} = 1.5 P ( {φ}_{f} {i}_{q} + ( {L}_{d} - {L}_{q} ) {i}_{d} {i}_{q} ) \qquad ( 3 )$$

Based on equation (3), it can be noted that a negative value of i_{d} 510 will ensure that Tₑ remains positive, which is favorable. Furthermore, the above equations (1), (2), and (3) can be combined to create equation (4).

$${T}_{e} = 1.5 P ( {Φ}_{f} {I}_{s} sin θ + 0.5 ( {L}_{d} - {L}_{q} ) {I}_{s}^{2} sin 2 θ ) \qquad ( 4 )$$

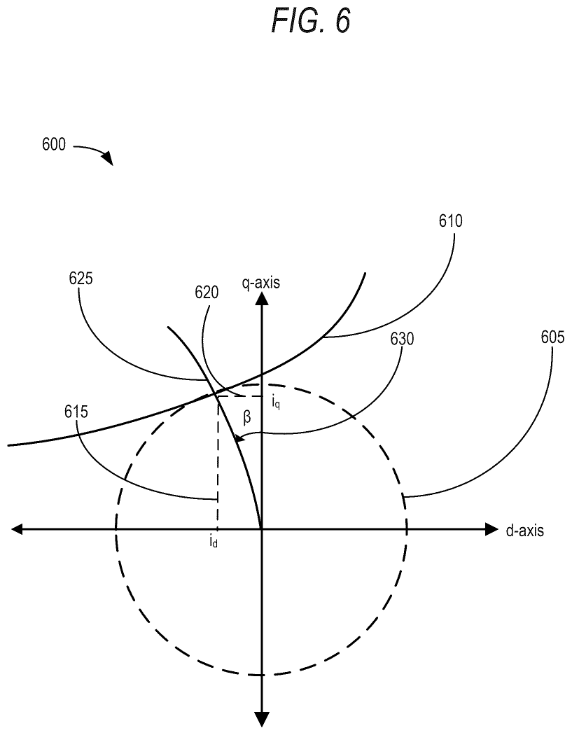

FIG. 6 is a graph 600 illustrating a negative stator flux current for use in field weakening determined by a max-torque-per-amps (“MTPA”) algorithm. In particular, the graph 600 illustrates an MTPA vector 625 generated by an MTPA block (for example, MTPA block 410) based on a crossing between of a constant current 605 and a constant torque 610 of the motor 308. In some embodiments, the MTPA vector 625 is a minimum current space vector that satisfies at least one constraint of the MTPA algorithm. The MTPA vector 625 further includes a beta-angle 630. In some embodiments, the beta-angle 630 is optimized between 0° and 45° from the q-axis. In some embodiments, the beta-angle 630 being between 0° and 45° is a constraint of the MTPA algorithm. The point at which the MTPA vector 625 crosses the constant current 605 and the constant torque 610 can be defined by a flux current i_{d} 615 and a torque current i_{q} 620. As can be seen by FIG. 6, at the point where the MTPA vector 625 is optimized, the flux current i_{d} 615 is negative in terms of the d-axis. In some embodiments, the MTPA vector 625 may be at a different beta-angle 630 while still satisfying being between 0° and 45° from the q-axis. However, in these embodiments, the MTPA vector 625 may not be a minimum current space vector, and therefore not optimized.

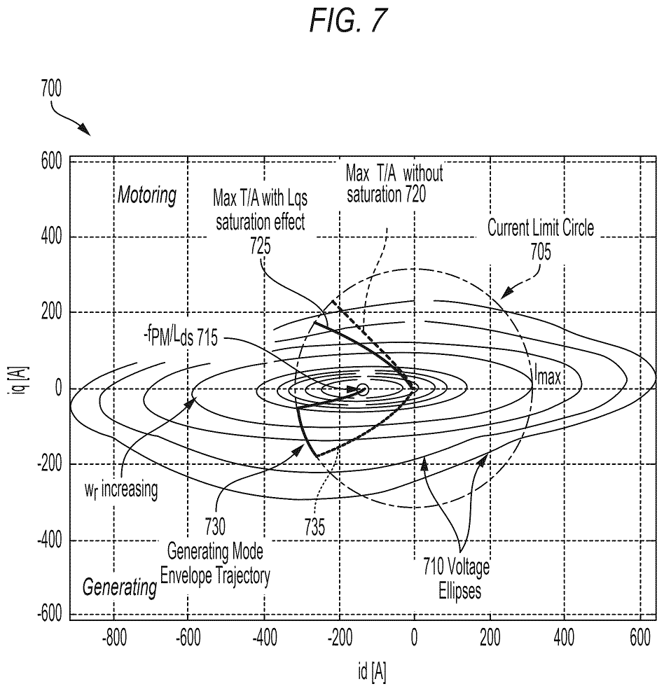

FIG. 7 is a graph 700 illustrating a relationship between stator flux current and stator torque current. The graph 700 includes a current limit 705 as a circle with an amplitude centered at the origin, and a voltage limit 710 as a family of nested ellipses centered at the point at which the MTPA vector is optimized (that is, the value of i_{d} counteracts the reluctance torque Tₑ based on equation [3]). The radii of the ellipses of the voltage limit 710 may vary inversely with a speed of the rotor of the motor 308. In some embodiments, the ellipses of the voltage limit 710 are distorted along the vertical q-axis because of a saturation effect, and the diameters of the ellipses of the voltage limit 710 exhibit a counter-clockwise tilt along the horizontal d-axis because of stator resistance effects. At any given speed, the motor 308 can operate at any combination of i_{q} and i_{d} values that falls within the overlapping area of the current limit 705 and the voltage limit 710 associated with that speed. The value of negative I_{d} at which it completely opposes and negates the permanent magnet flux of the motor 308 is identified at 715.

The graph 700 also includes a first MTPA vector 720 without the effects of magnetic saturation and a second MTPA vector 725 with the effects of magnetic saturation. The first MTPA vector 720 forms an angle with the negative d-axis that exceeds 45°, while the second MTPA vector 725 forms an angle with the negative q-axis that does not exceed 45°. The graph 700 also includes a maximum output power point 730 that follows the periphery of the current limit 705 towards the negative d-axis. This motion may be forced by the increasing speed that progressively shrinks the voltage limit 710, preventing the machine from operating based on the MTPA algorithm, identified by a dashed line 735.

The maximum output power point 730 for speeds above the corner point may be an optimistic outer limit for the current vector locus that can only be approached but never quite reached for an actual current regulated drive. This is true because the outer boundary of the voltage limit 710 at any speed corresponds to six-step voltage operation, representing a condition in which current regulator loops are completely saturated. Since a current regulator loses control of phase currents under such conditions, the current vector command can be continually adjusted so that it always resides safely inside the voltage limit 710. However, it is desirable to approach the voltage limit 710 as closely as possible under heavy load conditions in order to deliver maximum power from the motor 308, taking full advantage of the power supplied by the inverter 348. Therefore, the angle between the commanded current vector and the negative d-axis is reduced as the shrinking voltage limit 710 progressively intrudes on the current limit 705 for speeds above the corner point.

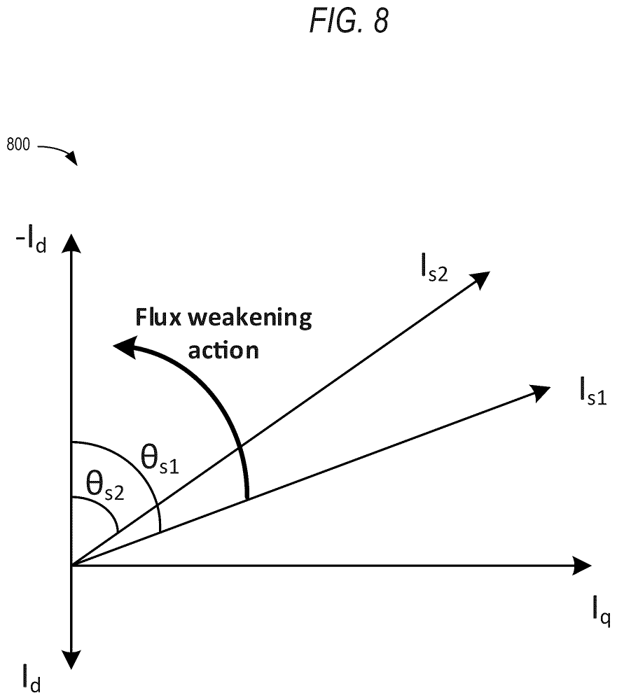

FIG. 8 is a graph 800 illustrating the results of a field weakening operation. Specifically, FIG. 8 illustrates how the angle, θ_{S}, between the commanded current vector, I_{S}, is reduced as the shrinking voltage limit 710 (see FIG. 7) progressively intrudes on the current limit 705 for speeds above the corner point.

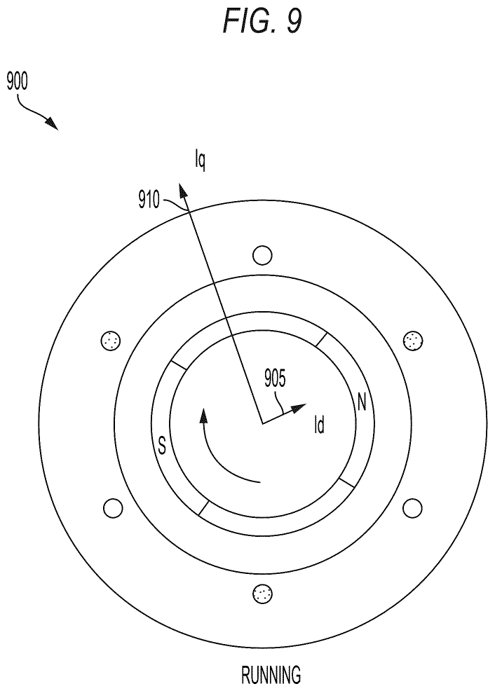

FIG. 9 is a graph 900 illustrating a relationship between stator flux current i_{d} 905 (i.e., a flux producing current) and stator torque current i_{q} 910 (i.e., a torque producing current) while driving a motor (e.g., the motor 308). Specifically, FIG. 9 illustrates that the stator torque current i_{q} 910 is controlled by the FOC controller 435 to have a greater magnitude than the stator flux current i_{d} 905 while performing a driving operation of the motor 308. By maintaining a greater magnitude of stator torque current i_{q} 910, the motor 308 produces a greater amount of torque during the driving operation.

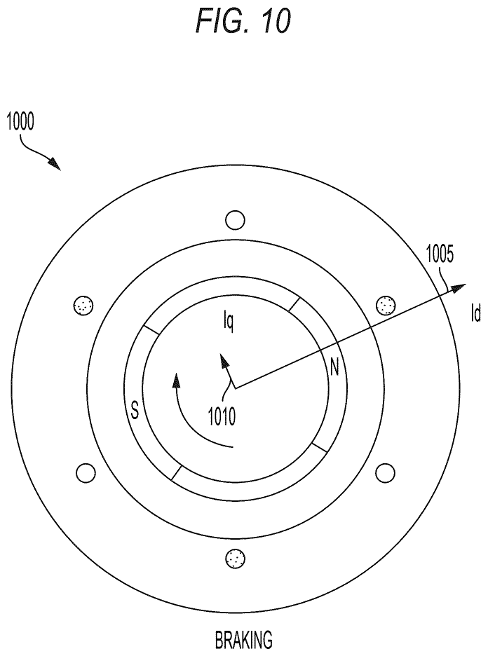

FIG. 10 is a graph 1000 illustrating a relationship between stator flux current i_{d} 1005 and stator torque current i_{q} 1010 while braking (i.e., performing flux braking) a motor (e.g., motor 308). In some embodiments, the stator flux current i_{d} 1005 and the stator torque current i_{q} 1010 correspond to the same vectors of current as the stator flux current i_{d} 905 and the stator flux current i_{q} 910 shown in FIG. 9, but are represented at different magnitudes. Specifically, FIG. 10 illustrates that the stator flux current i_{d} 1005 is controlled by the FOC controller 435 to have a greater magnitude than the stator torque current i_{q} 1010 while performing a braking operation of the motor 308. By maintaining a greater magnitude of stator torque current i_{d} 1005, the magnetic flux of the motor 308 is increased allowing the motor 308 to brake (i.e., flux braking) without experiencing a regenerative current or requiring separate energy absorbing components. In some embodiments, position sensing is maintained during flux braking.

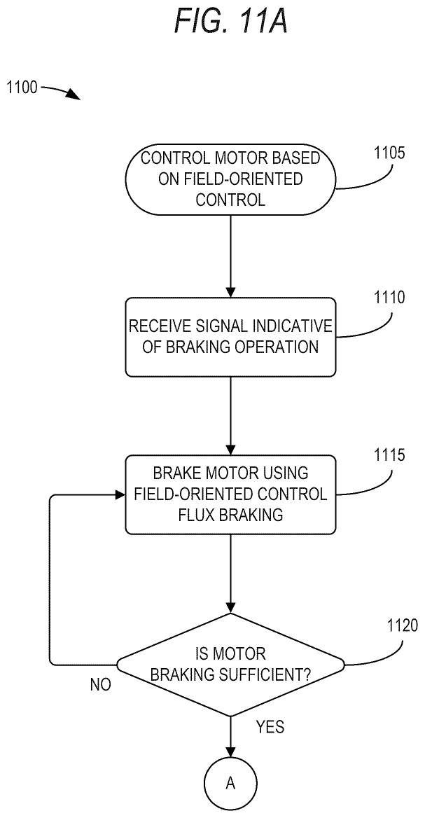

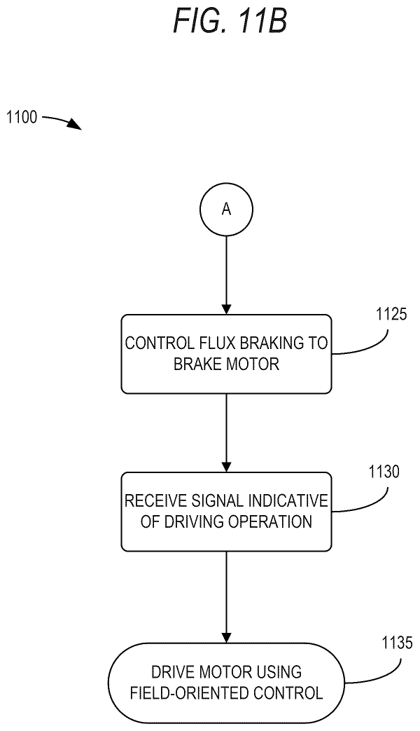

FIGS. 11A-11B illustrate a flow chart of a method 1100 for implementing the above described FOC control of the motor 308. The method 1100 begins with the controller 304 (e.g., including the FOC controller 435) controlling the motor 308 based on the FOC control algorithm (BLOCK 1105). The method 1100 includes the controller 304 receiving a first signal indicative of a braking operation of the motor 308 from a sensor (e.g., the current sensor 324, the temperature sensor 328, the trigger switch 316, a sensor connected to the user inputs 336, etc.) (BLOCK 1110). For example, the first signal is generated based on a detected fault condition of the motor 308, a detected fault condition of a FET, the release of the trigger 230, an overtemperature measurement by temperature sensor 328, or any other indication that a braking operation should be initiated. The method 1100 also includes the controller 304 generating or providing a command to brake the motor 308 using the FOC control algorithm (i.e., flux braking) (BLOCK 1115). The method 1100 further includes the controller 304 determining if the braking command supplied for controlling the motor 308 during the braking operation is sufficient to brake the motor 308 (e.g., brake the motor to a stop, brake to a stop in a period of time, etc.) (BLOCK 1120). If the braking command is not sufficient to complete the desired braking operation, the method 1100 returns to BLOCK 1115, and the controller 304 can modify the braking control to ensure that the braking command is sufficient to complete the desired braking operation (e.g., brake the motor to a stop, brake to a stop in a period of time, etc.). For example, the flux current i_{d} can be increased to a greater positive magnitude. The method 1100 can perform BLOCK 1115 and BLOCK 1120 as many times as necessary to adjust the braking command signal to ensure that the braking operation will be sufficient to brake the motor 308 according to the desired braking parameters (e.g., brake the motor to a stop, brake to a stop in a period of time, etc.).

With reference to FIG. 11B, if the braking command is sufficient to complete the desired braking operation (e.g., brake the motor to a stop, brake to a stop in a period of time, etc.), the controller 304 proceeds to continue to control the motor 308 using flux braking until the desired braking operation is completed (BLOCK 1125). The method 1100 also includes the controller 304 receiving a second signal indicative of a subsequent driving operation of the motor 308 (BLOCK 1130). For example, the second signal is generated based on a re-actuation or cycling of the trigger 230 that indicates that the user wants the motor 308 to perform another driving operation. The method 1100 also includes the controller 304 supplying a driving command to drive the motor 308 using the FOC control algorithm (BLOCK 1135). In some embodiments, the controller 304 continues to drive the motor 308 using the FOC control algorithm until the driving operation is completed. In other embodiments, the controller 304 receives a third signal indicative of a subsequent braking operation of the motor 308. If the controller 304 receives the third signal, the method 1100 returns to BLOCK 1105 to repeat the method 1100.

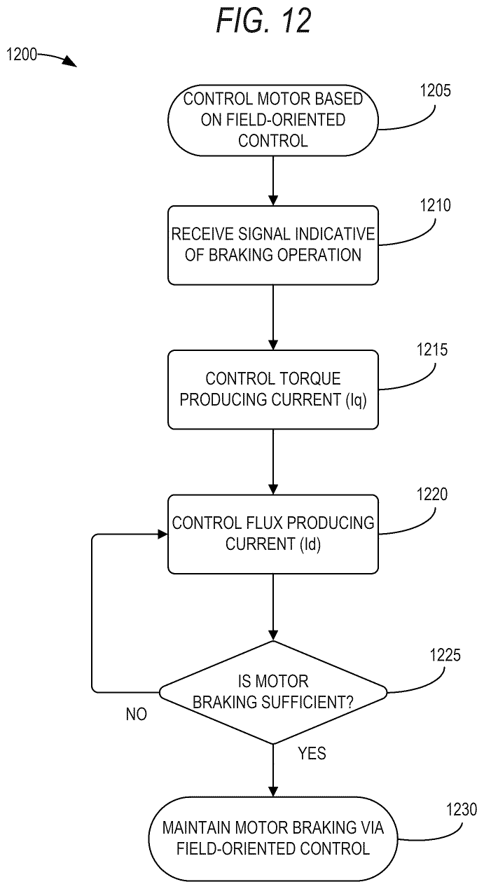

FIG. 12 illustrates a flow chart of a method 1200 for implementing flux braking of the motor 308 based on the FOC control algorithm described above. The method 1200 begins with the controller 304 (e.g., including the FOC controller 435) controlling the motor 308 based on the FOC control algorithm (BLOCK 1205). The method 1200 includes the controller 304 receiving a first signal indicative of a flux braking operation of the motor 308 (BLOCK 1210). For example, the first signal is generated based on a detected fault condition of the motor 308, a detected fault condition of a FET, the release of the trigger 230, an overtemperature measurement by temperature sensor 328, or any other indication that a braking operation should be initiated. To flux brake the motor 308, the method 1200 also includes generating or providing a second signal for controlling the motor 308 to control a first component of the current (e.g., the stator torque current i_{q} 1010) of the motor 308 (BLOCK 1215). In some embodiments, the controller 304 generates or provides the second signal to reduce the first component of current to be zero. The method 1200 further includes generating or supplying a third signal for controlling the motor 308 to control the second component of the current (e.g., the stator flux current i_{d} 1005) of the motor 308 (BLOCK 1220). In some embodiments, the controller 304 generates or provides the third signal to control the second component of the current to be zero or a positive value.

The method 1200 further includes the controller 304 determining if the third signal supplied for controlling the motor 308 during the braking operation is sufficient to brake the motor 308 (e.g., brake the motor to a stop, brake to a stop in a period of time, etc.) (BLOCK 1225). If the third signal is insufficient to complete the desired braking operation (e.g., brake the motor to a stop, brake to a stop in a period of time, etc.), the method 1200 returns to BLOCK 1220 and the controller 304 can modify the braking control to ensure that the braking command is sufficient to complete the desired braking operation (e.g., brake the motor to a stop, brake to a stop in a period of time, etc.). For example, the flux current i_{d} can be increased to a greater positive magnitude. The controller 304 supplies a fourth signal for controlling the motor 308 to control the second component and ensure that the braking operation will be sufficient to complete the braking operation (e.g., brake the motor to a stop, brake to a stop in a period of time, etc.). In some embodiments, the controller 304 determines that the third signal is insufficient by determining a battery voltage via the communication line 384, determining a battery current via the communication line 384, or determining a rotational speed of the of the motor 308. The controller 304 supplies the fourth signal based on at least one of the determined battery voltage, battery current, or rotational speed, etc. In some embodiments, the fourth signal is different (e.g., in magnitude) than the third signal. The method 1200 performs BLOCK 1225 as many times as necessary to ensure that the braking operation will be sufficient to brake the motor 308 (e.g., brake the motor 308 to a stop, brake to a stop within a period of time, etc.). If the braking command is sufficient to complete the desired braking operation, the controller 304 proceeds to maintain the motor 308 braking via the FOC control algorithm including the third signal or the fourth signal until the braking operation is completed (BLOCK 1230).

In some embodiments, the method 1200 includes the controller 304 receiving a fifth signal indicative of a subsequent driving operation of the motor 308. For example, the fifth signal is generated based on a cycling or re-actuation of the trigger 230 that indicates that the user wants the motor 308 to perform another driving operation. In some embodiments, the method 1200 also includes the controller 304 generating or providing a sixth signal for controlling the motor 308 to control the first component (e.g., the stator torque current i_{q} 1010) of the current of the motor 308 for the driving operation. In some embodiments, the sixth signal is similar to the second signal supplied by the controller 304 for the braking operation. In some embodiments, the method 1200 further includes generating or providing a seventh signal for controlling the motor 308 to control the second component (e.g., the stator flux current i_{d} 1005) of the current of the motor 308 for the driving operation. In some embodiments, the seventh signal is similar to the third signal supplied by the controller 304 for the braking operation. In some embodiments, the controller 304 supplies the seventh signal to reduce the second component of the current to, for example, zero. Reducing the second component of the current to zero allows the controller 304 to maximize the torque supplied by the motor 308. In some embodiments, the method 1200 returns to BLOCK 1205 following a driving operation when the controller 304 receives a user input. For example, the user input could be a release of the trigger 230 during the driving operation.

Thus, embodiments described herein provide systems and methods for implementing flux braking on a power tool including a brushless DC motor controlled via field-oriented control. Various features and advantages are set forth in the following claims.

1-14. (canceled)

15. A power tool comprising:
a housing;
a handle;
a brushless motor within the housing, wherein the brushless motor includes a rotor and a stator, wherein the rotor is coupled to a motor shaft arranged to rotate about a longitudinal axis, the longitudinal axis extending through the motor shaft, and wherein the motor shaft is arranged to produce a rotational output to a drive mechanism;
a sensor configured to sense a parameter of the brushless motor;
a power switching circuit configured to provide a supply of power from a power source to the brushless motor; and
an electronic controller configured to apply a field-oriented control (“FOC”) technique to control the brushless motor, the electronic controller configured to:
receive, after a flux braking operation of the brushless motor and via the sensor, a first signal indicative of a driving operation of the brushless motor,
generate a second signal to control a first component of a current of the brushless motor to drive the brushless motor, and
generate a third signal to control a second component of the current of the brushless motor to drive the brushless motor.

16. The power tool of claim 15, wherein the first component of the current indicates a torque producing current (i_{q}).

17. The power tool of claim 15, wherein the second component of the current indicates a flux producing current (i_{d}).

18. The power tool of claim 15, wherein to generate the third signal includes the electronic controller being configured to reduce the second component of the current to be zero.

19. The power tool of claim 18, wherein to reduce the second component to zero maximizes torque supplied by the brushless motor.

20. The power tool of claim 15, wherein the electronic controller is further configured to:
receive a user input; and
brake, in response to the user input, the brushless motor.
